(19) United States
(12) Patent Application Publication
(10) Pub. No.: US 2015/0263893 A1
(43) Pub. Date: Sep. 17, 2015

(54) User Exchange Interface (UXI) System, Apparatus, and Method Thereof

(71) Applicant: International Communications Corp., Riverside, CA (US)

(72) Inventors: Keith M. Alexis, Riverside, CA (US); Salman H. Qureshi, Mission Viejo, CA (US)

(73) Assignee: International Communications Corp., Riverside, CA (US)

(21) Appl. No.: 14/645,381

(22) Filed: Mar. 11, 2015

Related U.S. Application Data
(60) Provisional application No. 61/951,443, filed on Mar. 11, 2014.

(51) Int. Cl. H04L 12/24; H04L 29/12

(52) U.S. Cl. CPC H04L 41/0806; H04L 61/2015; H04L 61/6068

(57) ABSTRACT

The present invention relates generally to a user exchange interface (UXI) system, apparatus, and a method of using same. More particularly, the invention encompasses a framework for a service provider/client management-focused interface designed to change the process of device deployment, setup, configuration and installation. The invention is designed to interface with complex computer data networking devices, where the platform accepts minimal setup details from the user, connects to the devices, circumvents traditional complex interface elements to establish connection, usability, and performance for the user. Furthermore, the framework sets up a new and improved series of processes for integration between client, device, IT organization, and service provider, to name a few. To keep development and flexibility and integration for third party developer/user the invention uses simple and well used programming language and environment for the Application (App) called .NET and C#.

### CROSS-REFERENCE TO RELATED APPLICATION

The instant patent application claims priority to and the benefit of pending U.S. Provisional Patent Application Ser. No. 61/951,443, filed on Mar. 11, 2014, titled “User Exchange Interface (UXI) System, Apparatus, And Method Thereof,” the entire disclosure of which provisional application is incorporated herein by reference.

### FIELD OF THE INVENTION

The present invention relates generally to a user exchange interface (UXI) system, apparatus, and a method of using same. More particularly, the invention encompasses a framework for a service provider/client management-focused interface designed to change the process of device deployment, setup, configuration and installation. The invention is designed to interface with complex computer data networking devices, where the platform accepts minimal setup details from the user, connects to the devices, circumvents traditional complex interface elements to establish connection, usability, and performance for the user. Furthermore, the framework sets up a new and improved series of processes for integration between client, device, IT organization, and service provider, to name a few. To keep development and flexibility and integration for third party developer/user the invention uses simple and well used programming language and environment for the Application (App) called .NET and C#.

### PURPOSES AND SUMMARY OF THE INVENTION

The invention is a novel user exchange interface (UXI) system, apparatus, and a method of using same.

Therefore, one purpose of this invention is to provide an apparatus where multiple devices can be configured using a single device.

Another purpose of this invention is to provide a system where a minimum number of steps are needed to configure a plurality of devices simultaneously.

Therefore, in one aspect this invention comprises a method of configuring a plurality of electronic devices comprising:

providing a user exchange interface (UXI) capable of connecting to the electronic devices to be configured;
using the user exchange interface (UXI):
establishing a connection with the electronic devices to be configured at the same time; negotiating protocols with the electronic devices while all the electronic devices are connected;
validating connection with and authentication of the electronic devices while all the electronic devices are connected;
applying initial settings and protocols with the electronic devices while all the electronic devices are connected; and
configuring the electronic devices while all the electronic devices are connected; and disconnecting communication between the user exchange interface (UXI) and the electronic devices,
wherein each of the plurality of electronic devices are capable of being separately operated as configured.

In another aspect this invention comprises an apparatus for configuring a plurality of electronic devices comprising:

a user exchange interface (UXI) capable of connecting to the electronic devices to be configured;
said user exchange interface (UXI):
having means of establishing a connection with the electronic devices to be configured at the same time;
having means of negotiating protocols with the electronic devices while all the electronic devices are connected;
having means for validating connection with and authentication of the electronic devices while all the electronic devices are connected:
having means of applying initial settings and protocols with the electronic devices while all the electronic devices are connected; and
configuring the electronic devices while all the electronic devices are connected; and disconnecting communication between the user exchange interface (UXI) and the electronic devices, and
wherein each of the plurality of electronic devices are capable of being separately operated as configured.

In yet another aspect this invention comprises a non-transitory computer-readable storage medium with an executable program application stored thereon, the program application configured for coordinating to perform transactions associated with configuring a plurality of electronic devices, the program application configured to be accessible over a communications network, wherein the program application instructs a computer processor to perform the following steps of:

providing a user exchange interface (UXI) capable of connecting to the plurality of electronic devices to be configured;
using the user exchange interface (UXI):
establishing a connection with the electronic devices to be configured at the same time; negotiating protocols with the electronic devices while all the electronic devices are connected;
validating connection with and authentication of the electronic devices while all the electronic devices are connected;
applying initial settings and protocols with the electronic devices while all the electronic devices are connected; and
configuring the electronic devices while all the electronic devices are connected; and
disconnecting communication between the user exchange interface (UXI) and the electronic devices,
wherein each of the plurality of electronic devices are capable of being separately operated as configured.

### BRIEF DESCRIPTION OF THE DRAWINGS

FIG. 1, illustrates a first embodiment for a user interface, and a backend of the invention implementation and the relay logic between the user interface and the backend design.

FIG. 2, illustrates a second embodiment for a user interface, and a backend of the invention implementation and the relay logic between the user interface and the backend design.

FIG. 3, illustrates an embodiment for an interface between a UI (User Interface) and a backend (Relay Logic).

FIG. 4, illustrates an embodiment for a backend which could be used for both the User Interface for an Access Point (AP), and the User Interface for an Access Controller (AC).

FIGS. 5, 6, 7, and 8, illustrate an embodiment of an application development flow layout or flow chart.

FIG. 9, illustrates a network configuration according to yet another embodiment of this invention.

### DETAILED DESCRIPTION

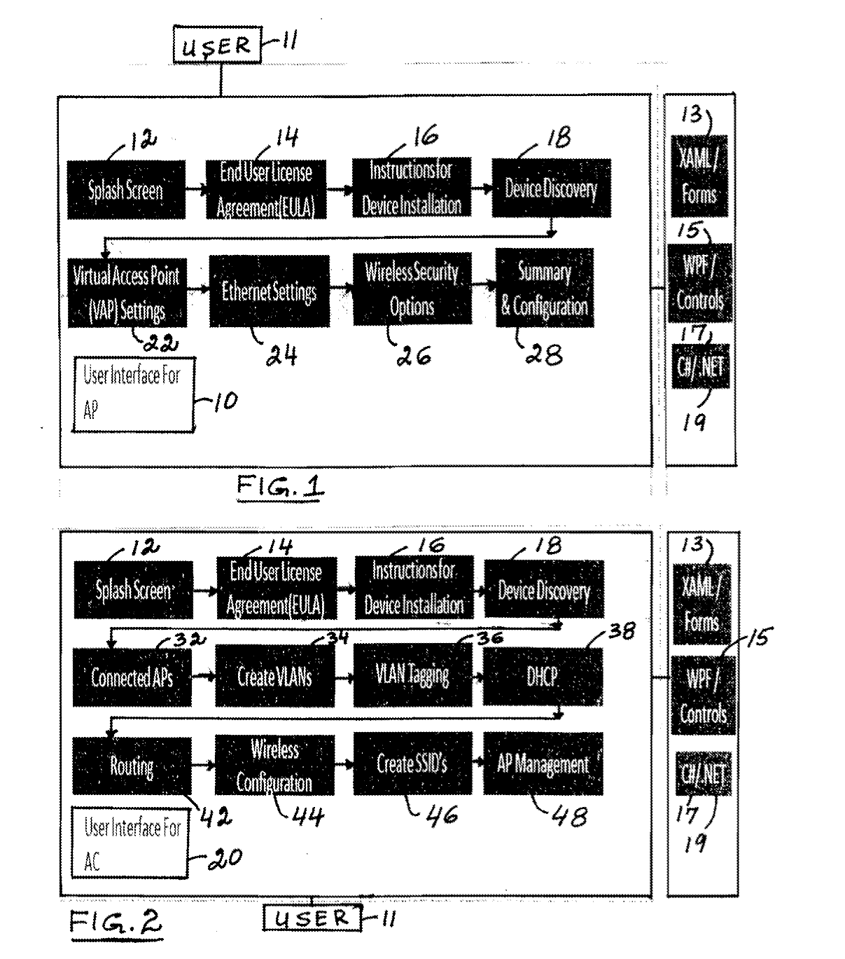

The inventive user exchange interface (UXI) system, apparatus, and a method of using same will now be discussed with reference to FIGS. 1 through 9. Although the scope of the present invention is much broader than any particular embodiment, a detailed description of the preferred embodiment follows together with drawings. These drawings are for illustration purposes only and are not drawn to scale. Like numbers represent like features and components in the drawings.

As we move towards a super hyper-connected world, a different use for software emerges as a way to dynamically handling some of the various routing, management, and other data control points of the network. Removing some of the intelligence from the data plane, software-driven systems strive to unlock the pent up efficiency that is held-up by traditional data network ecosystems. Driven by demand, the data network has proven to be one of the few major bottlenecks as users demand more communication and content services. Software-driven networks provide tools to route and create virtual environments, and they continue to become a real option for optimization, deployment, and management for more network environments. Additionally, with the combination and consolidation at the client level has resulted in reducing the client network ecosystem footprint while obtaining additional savings and green energy advantages.

Therefore, a major impact in the adoption of technology as a medium for communication is its ease-of-use and interfacing with the user. The User Exchange Interface (UXI) is designed to make it easier for users to interface with the devices they are attempting to manage or better control. This invention provides a simple configuration or a fast configuration scheme.

The invention uses unique device machine addresses to initiate connections with multiple networking devices that could all be in default configuration or out-of-box mode and would all be on the same physical IP (Internet Protocol) address. This invention addresses the mass configuration requirements of products that otherwise would have to be dealt with one at a time or more user touches would otherwise be required to be able to configure them.

While the internal working processes are complex, the user interface and actions to set up the apparatus are very simple, as more clearly shown and described in FIG. 1, through 9.

With this invention the user has to only enter a few various option screens and the application automatically established device connection, negotiates all protocols, validates connection and authentication, applies initial settings and protocols, and allows the user to quickly access and configure the unit, number of units in the system, or the whole product line deployed in a network domain. The product could be one supplied by anyone, including a third party source.

This invention has significant value for setting up multiple devices, when compared to current industry standards for setting up one device at a time for a network use, as it shortens the time to use by at least 75 percent, if not more.

Some of the advantages provided by this invention are, for example, it as software driven solution. It reduces time spent for set-up and deployment, as it is a simple user interface, which substantially reduces potential errors. It reduces the cost of preparation for networking installations, and reduces installation time. It reduces total operating expenditures. It also reduces training needed by IT and installation professionals. It provides a faster time to deployment by automating the hyper-terminal setup and connection, log in, along with the system status checks. It reduces the barrier for technology use as more less technical persons can use a network device. It increases the use of higher end networking devices by a greater and less technical market group. Due to its simplistic setup it increases installation efficiency with fewer items that could go wrong, and thus improves on performance and return on investment for a user or client. It also opens up the historically proprietary nature of vendor data networking devices to a faster configuration and setup.

This invention also solves many of the problems of the prior art, especially, for connecting to an advanced managed device of the prior art required, for example, an extensive knowledge to use the device, thus it increased deployment costs due to prolonged set up times. This also increased errors and delays when configuration options are not correct. Also, many parameters were proprietary to each vendor and could change, which required client or user changes. Also, multiple devices within a system had to be accessed and configured individually, one at a time, to complete the configuration of the complete network of deployed devices. The prior art tools tend to compliment the proprietary vendor product they work with and do not seek to remove the vendor complexity, let alone avoid parts of that vendor set up systems. Also, lower end systems made for end user consumers have been focused on connectivity for a single product.

The User Exchange Interface (UXI) system or platform of this invention has value for various industry segments, such as, for example, it reduces client or user deployment times, and increases deployment efficiency, while reducing technical setup and training time and requirements. It also simplifies training for a third party vendor or installer, and reduces specialized regional trainings.

The User Exchange Interface (UXI) system or platform of this invention has also value for users or customers, as it reduces operational expenses due to lower installation fees, and it increases cash for capital expenditures. For a user or a customer it also reduces down time and increased workable use time, and it has exponential value as the deployment increases in size and complexity. It also seeks to eliminate the complexity of user connection to their enterprise networking device or devices.

The industry value from this invention increases because as connectivity demands increases, the handling of the data traffic requires more complex systems and software. This inventive system reduces the complexity and barriers to handling those complex environments. Also, by reducing the initial complexity, this invention enables user to access higher end technology that then ensures delivery of their content.

The invention or the “Fast Configuration Wizard”, was built using Model View ViewModel (MVVM) as an architectural pattern for software development, and the Integrated Development Environment.

In order to better understand development components of the invention one should understand components of Windows Forms application design and Model View ViewModel (MVVM) pattern.

The Windows Forms components provide the layout for application, including controls, and it also consists of the GUI (graphical user interface) for the application. The controls are the functional blocks, and where different controls are being used in this application namely text box, tab control, buttons, and labels, to name a few. Each control has a different function to take input text to display labels and buttons for performing operation using their on click events. The backend programming language C# is being used by the application. Different classes are used with different name spaces. The logic behind each button click and every other logic is developed using C#. C# takes a control name as reference for the control.

Model View ViewModel (MVVM) architectural pattern components were separated into three components, namely, Model, View, and ViewModel. Model was used to hold the actual business logic. Model was unaware of both View and ViewModel. AC (Access Controller) and AP (Access Point) configuration parameters were used, and Model was developed using C# for coding and logic building. In View all elements were displayed by the GUI (Graphic User Interface), such as, buttons, text, and other controls. View was aware of ViewModel only, and used a GUI. View was developed using Extensible Application Markup Language (XAML), and Windows Presentation Foundation (WPF), and Windows Forms Graphics Subsystem. ViewModel is an abstraction of the View, and it also served in mediating between the View and the Model. ViewModel was aware of both View and Model. For most applications ViewModel remains hidden from End User. ViewModel was developed using C# Controls.

For the Framework, it is preferred to use Microsoft .NET 4 and onwards. For the programming language, it is preferred to use C#v5.0. Graphical subsystem was developed using Windows Forms/Windows Presentation Foundation (WPF). The programming language for the GUI (Graphic User Interface) one could use C# for Windows Forms/XAML. For design pattern or tab controls one could use Model View ViewModel (MVVM).

FIG. 1, illustrates a first embodiment for a user interface, and a backend of the invention implementation and the relay logic between the user interface and the backend design. For most applications, for example, for a User Interface for an Access Point (AP) 10, one could have an initial or splash screen 12, which could be preferably followed by an End User License Agreement (EULA) 14. If a user 11, accepted the EULA 14, then the user 11, would be taken to, for example, a screen for instructions for device installation 16. However, if a user 11, rejects the EULA 14, then the configuration scheme would end, and the user 11, would not be able to move forward with the desired configuration of the device(s). However, for a user 11, who has accepted the EULA 14, the user 11, could then review the instructions for device installation 16, or could click on a button to move to the device discovery screen 18. Once the device(s) to be configured 19a, 19B, . . . , 19N, have been detected, the user 11, could then move over to the Virtual Access Point (VAP) setting screen 22, where all the virtual access point (VAP) settings could be established. The user 11, would then establish the Ethernet settings or connections 24, at the next screen, and if the device had a wireless connection then a wireless security options 26, would be established, and the system would then be activated to update and configure all the connected devices as desired by the user 11. One could also set wireless configuration 26, by entering a Group ID, and selecting AP (Access Point) Profile from a list that appears on a screen 15. Optionally, a screen or location 28, would also be available to a user 11, for a summary and configuration. For the User Interface for an Access Point (AP) 10, it is preferred to use Extensible Application Markup Language (XAML), and Windows Forms Graphics Subsystem 13, with Windows Presentation Foundation (WPF) 15, for controls, and C# 17, and .NET 19, for framework.

FIG. 2, illustrates a second embodiment for a user interface, and a backend of the invention implementation and the relay logic between the user interface and the backend design. For most applications, for example, for a User Interface for an Access Controller (AC) 20, one could have an initial or splash screen 12, which could be preferably followed by an End User License Agreement (EULA) 14. If a user 11, accepted the EULA 14, then the user 11, would be taken to, for example, a screen for instructions for device installation 16. However, if a user 11, rejects the EULA 14, then the configuration scheme would end, and the user 11, would not be able to move forward with the desired configuration of the device(s). However, for a user 11, who has accepted the EULA 14, the user 11, could then review the instructions for device installation 16, or could click on a button to move to the device discovery screen 18. Once the device(s) 19a, 19B, . . . , 19N, have been detected, the user 11, could then move over to the Connected Access Points (APs) setting screen 32, where all the connected access point (APs) settings could be reviewed. The user 11, could then create VLAN(s) (Virtual Local Area Network) at 34, and then the virtual local area network at 34, and then Virtual Local Area Network (VLAN) Tagging could be done at 36. VLAN Tagging 36, could also include adding VLAN trunk, native VLAN, and allowed VLAN option after VLAN's creation on separate UI (User Interface). The user 11, could then move over to screen 38, to establish Dynamic Host Configuration Protocol (DHCP) 38, which is a network protocol that enables a server to automatically assign an IP address to a computer from a defined range of numbers configured for a given network. One could also implement basic DHCP configuration 38, on a separate UI (User Interface) 15. A routing path 42, could be established at screen 42. One could also implement routing protocols 42, with basic configuration, such as, Static/Default, RIP v1, RIP v2, OSPF. If the device had a wireless connection then a wireless configuration 44, would be done at screen 44. One could also set wireless configuration 44, by entering a Group ID, and selecting AP (Access Point) Profile from a list that appears on a screen 15. At screen 46, the user 11, would create SSID's (Service Set Identifiers). SSIDs are a case sensitive, 32 alphanumeric character unique identifier attached to the header of packets sent over a wireless local-area network (WLAN) that acts as a password when a mobile device tries to connect to the basic service set (BSS), and it is a component of the IEEE 802.11 WLAN architecture. One could also create SSID's 46, by entering SSID, network ID, and connected AP MAC address on screen 15, or 46. The user 11, then would conduct AP (Access Point) Management at screen 48. For the User Interface for an Access Controller (AC) 20, it is preferred to use Extensible Application Markup Language (XAML), and Windows Forms Graphics Subsystem 13, with Windows Presentation Foundation (WPF) 15, for controls, and C# 17, and .NET 19, for framework.

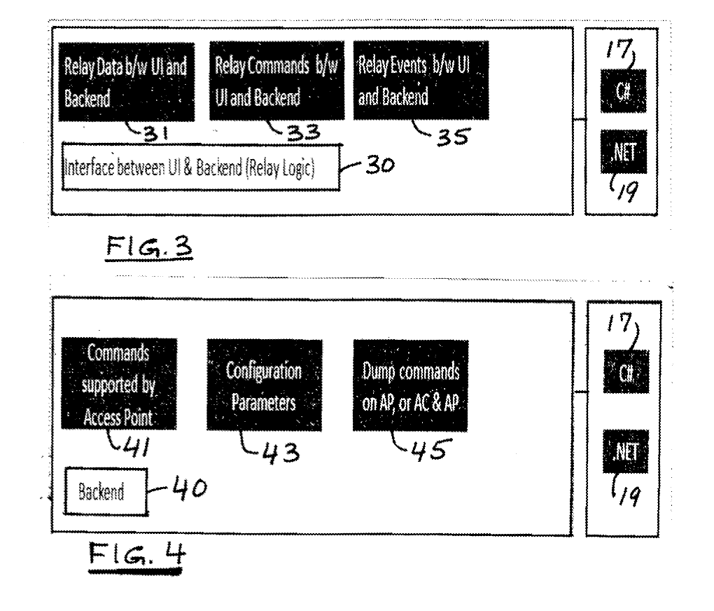

FIG. 3, illustrates an embodiment for an interface between a UI (User Interface) and a backend (Relay Logic) 30, which could be used for both the User Interface for an Access Point (AP) 10, and the User Interface for an Access Controller (AC) 20. The interface 30, could comprise of a relay data between UI (User Interface) and backend 31, a relay commands between UI (User Interface) and backend 33, and a relay events between UI (User Interface) and backend 35. One could use C# 17, and .NET 19, for framework.

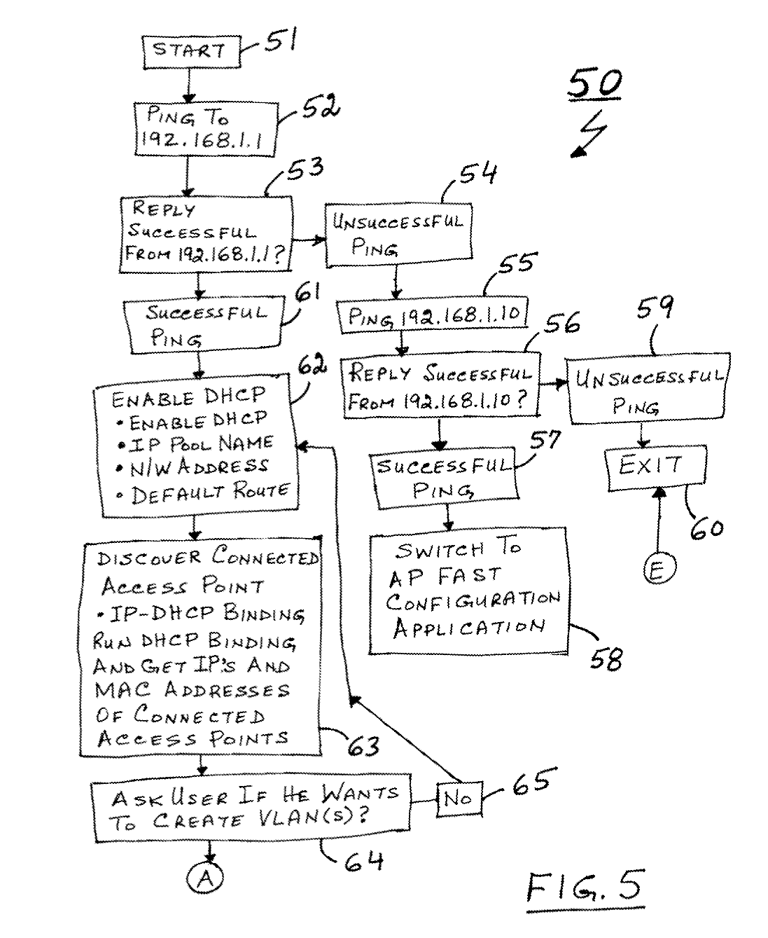

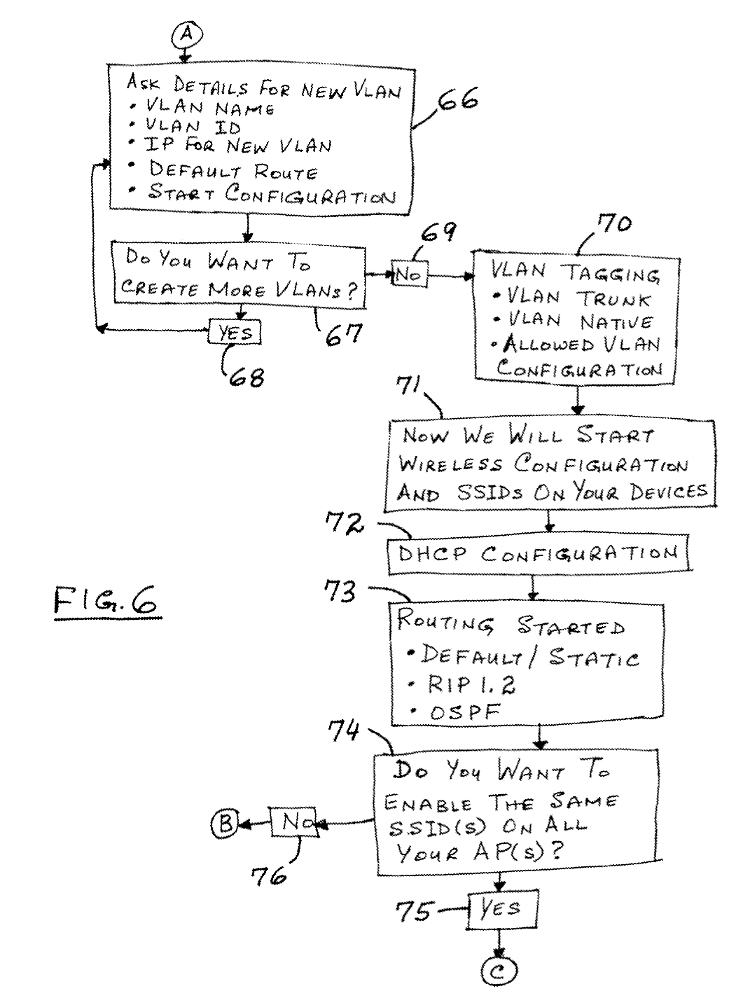

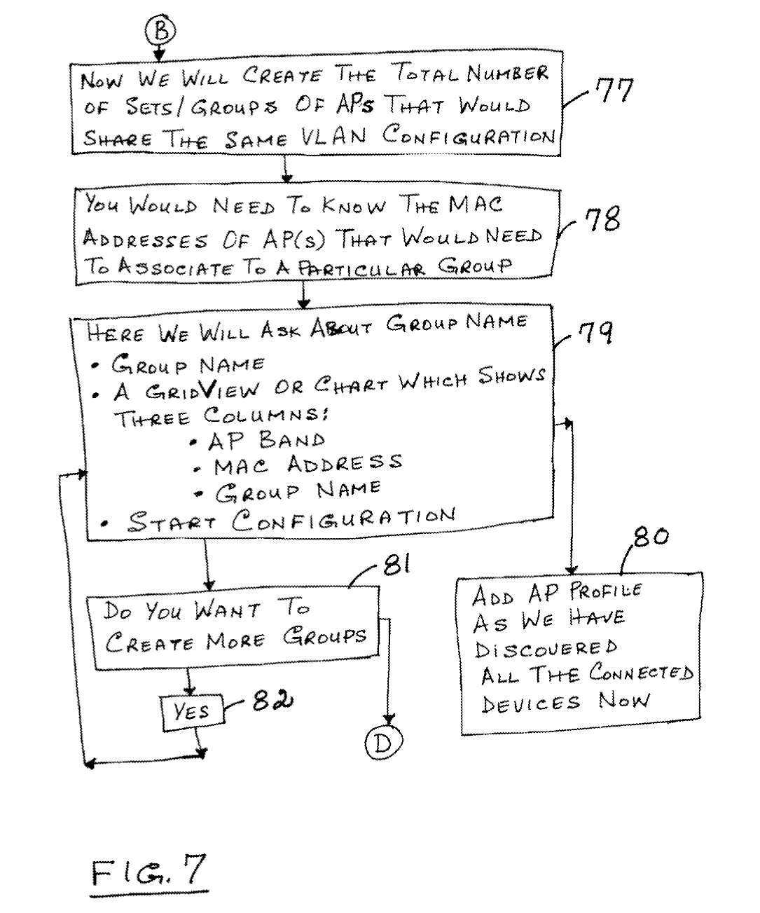

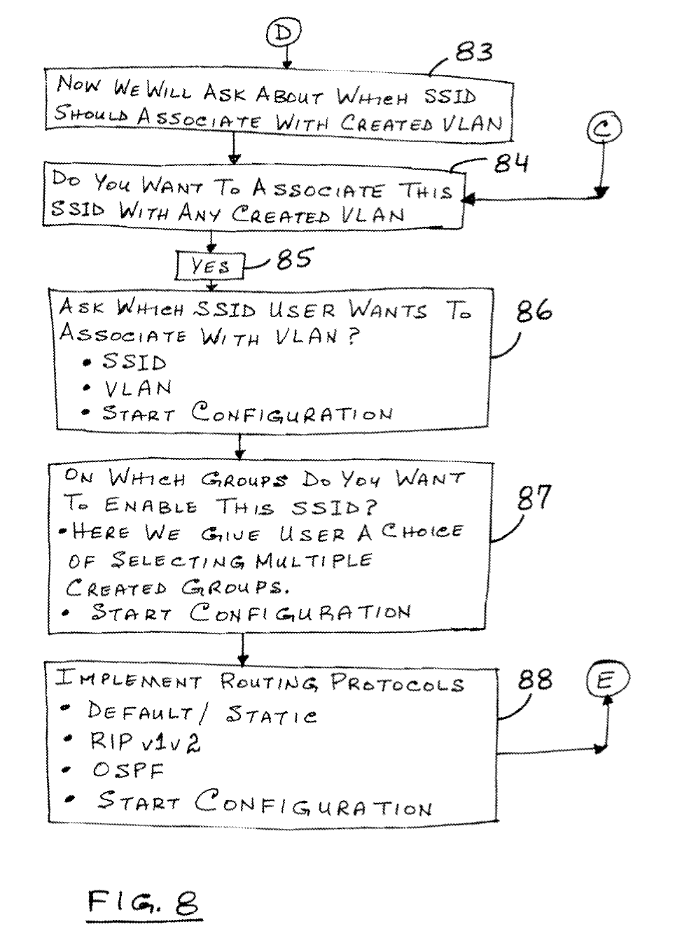

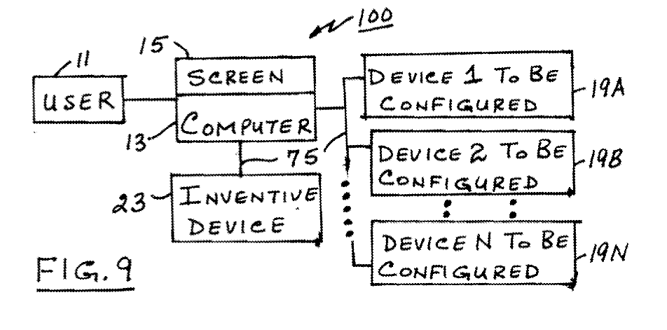

FIG. 4, illustrates an embodiment for a backend 40, which could be used for both the User Interface for an Access Point (AP) 10, and the User Interface for an Access Controller (AC) 20. The backend 40, could comprise of commands supported by AP (Access Point) 41, Configuration parameters 43, and dump commands on AP (Access Point), or AC (Access Controller) and AP (Access Point) 45. One could use C# 17, and .NET 19, for framework.

“Fast Configuration Wizard” has been designed to setup basic network configuration, involving user-friendly step-by-step environment. The products deployed can be categorized as Access Points (AP) only, or both Access Controller (AC) and Access Points (AP).

The “Fast Configuration Wizard” can be categorized according to two possibilities of product deployment as outlined earlier, and these features are further detailed below for both cases:

1. Access Points (AP) Only

1. AP Configuration
1.1. Discover connected APs
   1.1.1. Total number of AP(s)—this tool will be able to connect to a network and discover multiple FAT APs
   1.1.2. Could look up via the MAC. Address Table
   1.1.3. Able to accept inbound telnet sessions
   1.1.4. Types of AP(s)—ICC APs
1.2. Mode conversion from FIT to FAT
1.3. IP Address configuration
1.4. Country Setup
1.5. Language Selection (Optional)
1.6. Virtual Access Point(s) setup
   1.6.1. Select WLAN (2.4 GHz and 5 GHz)
   1.6.2. SSIDs (server set identification) setup
   1.6.3. VLAN virtual local area network setup
   1.6.4. VLAN ID
   1.6.5. IP Addresses
1.7. Security setup
   1.7.1. None
   1.7.2. Static WEP
   1.7.3. WPA Personal
   1.7.4. WPA Enterprise

2. Both Access Controller (AC) and Access Points (AP)

### 1. Access Controller (AC) Configuration

1.1 Enable DHCP
1.2 Discover connected Access controllers—active500EM, Link2000ACS, Link 1000ACS
1.3 Discover connected Access points
   1.3.1 Total number of AP(s)
   1.3.2 Types of AP(s)—ARC100MAP, ARC2000MAP, ICX200WAP, ICX400GAP, ICX420GAP
1.4 Create VLAN(s)
   1.4.1 VLAN Interface setup
   1.4.2 VLAN Tagging
1.5 Routing
   1.5.1 Static
   1.5.2 RIP (Remote Imaging Protocol or Routing Information Protocol) V1
   1.5.3 RIP V2
   1.5.4 OSPF (Open Shortest Path First)—OSPF is a routing protocol for Internet Protocol (IP) networks. It uses a link state routing algorithm and falls into the group of interior routing protocols, operating within a single autonomous system (AS)).
1.6 Create SSID(s) (Server Set Identification)
1.7 Create AP Groups or add AP Profiles
1.8 Associate SSID(s) (server set identification) with a particular VLAN(s) (as select by the user)
1.9 Enable SSID(s) on created Group(s)
   2. Access Point (AP) Provision
   2.1. Discover connected AP(s)
   2.2. Total number of AP(s)
   2.3. Types of AP(s)
   2.4. Provision discovered types automatically
   3. Access Point (AP) Configuration
   3.1. AP Group Configurations
   3.2. Discover connected APs
      3.2.1. Total number of AP(s)
      3.2.2. Types of AP(s)
   3.3. IP Address configuration
   3.4. Country Setup
   3.5. Virtual Access Point(s) setup
      3.5.1. Select WLAN (2.4 GHz & 5 GHz)
      3.5.2. SSIDs setup
      3.5.3. VLAN setup
      3.5.4. VLAN Id
      3.5.5. IP Address
   3.6. Security setup
      3.6.1. None
      3.6.2. Static WEP
      3.6.3. WPA Personal
      3.6.4. WPA Enterprise

FIGS. 5, 6, 7, and 8, illustrate an embodiment of an application development flow layout or flow chart 50. A user 11, would start at 51, and ping to, for example, 192.168.1.1 at 52. At 53, a check would be made to see if the reply was successful from 192.168.1.1. If the ping was unsuccessful at 54, the system or the user would then ping to, for example, 192.168.1.10, at 55, and then at 56 see if the reply was successful from 192.168.1.10. If the ping was unsuccessful at 59, then the user or system would exit at 60. However, if the reply at 56, resulted in a successful ping 57, then the program would be instructed to switch to AP (Access Point) fast configuration application at 58. Now, going back to location 53, if the reply at location 53, resulted in a successful ping 61, then the program would be instructed to enable Dynamic Host Configuration Protocol (DHCP), establish an IP (Internet Protocol) pool name, establish a Network address, and create a default route at 62. At step 63, the program would discover connected AP (Access Point), create IP (Internet Protocol) Dynamic Host Configuration Protocol (DHCP) binding, and then run DHCP binding and get IP's and MAC addresses of connected AP (Access Points). At step 64, a user 11, would be asked if the user 11, wants to create virtual local area network(s) (VLAN(s)). If the answer is no at step 65, then the program would be directed to go back to step 62, and continue the process, otherwise the program would go onto step 66, which would ask the user 11, or the system for details for a new VLAN, including VLAN name, VLAN Identification, Internet Protocol for the new VLAN, or go to the default route, and start the configuration. At step 67, the user 11, or the system would be asked if one wants to create more VLAN(s), if the answer at 68, is yes, then the program would be routed back to step 66, to continue the creation of new VLAN, otherwise if the answer is no at step 69, then the program would move to step 70, for VLAN tagging, and identifying VLAN trunk or VLAN native, and then continue VLAN configuration. At step 71, one would start wireless configuration and SSIDs on the devices. At step 72, DHCP configuration would be done, and then at step 73, routing would be started, including establishing Default, Static, Routing Information Protocol (RIP) 1.2, and Open Shortest Path First (OSPF). At step 74, the program would ask if the user 11, or the system wants to enable the same SSID(s) on all the AP(s) (Access Points), if the answer is no at step 76, then at step 77, the system would announce that it will create the total number of sets/groups of APs (Access Points) that would share the same VLAN configuration. At step 78, the user 11, or the system would be asked for the MAC addresses of AP(s) that would need to be associated to a particular group. At step 79, the user 11, or the system would be asked about a group name, and a grid view or chart would be used to show, say in three columns, the AP band, MAC address, and the group name, and then the system would start the configuration. At step 80, the program would add AP profile, as all the connected devices have now been discovered. Otherwise, the program would go to step 81, where the user 11, or the system would be asked if more groups need to be created, and if he answer is yes at step 82, then the program would loop back to step 79, otherwise it would move onto step 83. At step 83, the user 11, or the system would be asked about which SSID should associate with created VLAN. At step 84, the user 11, or the system would be asked if one wants to associate the SSID with any created VLAN, and if the answer is yes at step 85, then the user 11, or the system would be asked at step 86, which SSID the user 11, want to associate with VLAN, including identifying SSID, VLAN, and then the configuration would be started. At step 87, the user 11, or the system would be asked which group does one want to enable this SSID, and here the user would be given a choice of selecting multiple created groups, before the start of the configuration. At the step 88, the user 11, or the system would have the opportunity to implement routing protocols, including default or static, RIP v1, v2, Open Shortest Path First (OSPF), before starting the configuration. Once routing protocols has been implemented at step 88, the program would exit at step 60.

FIG. 9, illustrates a network configuration 100, according to yet another embodiment of this invention, where a user exchange interface (UXI) apparatus or controller or inventive device 23, is paired with a computer or electronic device 13, having a screen 15. The computer 13, could be a standalone system, such as, an iPad 13, a laptop 13, or it could be a server 13, or it could be linked to a server via a network 75. The inventive device 23, is allowed to communicate with devices to be configured, such as, device 1, 19A, device 2, 19B, . . . , device N, 19N. The inventive device 23, could be a part of the computer 13, or it could be a standalone device 23. The inventive device 23, can communicate with any of the components or devices via communication network 75, where the communication network 75, could be a hardwired network 75, or a wireless network 75. A user 11, provides the requested input to the inventive device or controller 23, to help configure the devices to be configured, namely, devices 19A, 19B, . . . , 19N. Once the devices to be configured, namely, devices 19A, 19B, . . . , 19N, are configured, the user exchange interface (UXI) apparatus or inventive device 23, is then removed from the network 75, and the configured devices 19A, 19B, . . . , 19N, continue to operate as configured.

The user exchange interface (UXI) apparatus 23, used in the preset invention, may be implemented using one or more computers 13, executing software instructions. According to one embodiment of the present invention, the computer 13, having a screen 15, may communicate with a server and client computer systems 13, that transmits and receives data over a computer network or a fiber or copper-based telecommunications network 21. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus tools used in the present invention are not limited to any specific combination of hardware circuitry and software, nor to any particular source for the instructions executed by the server or client computers. In some instances, the client and server functionality may be implemented on a single computer platform.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method of configuring a plurality of electronic devices comprising:
providing a user exchange interface (UXI) capable of connecting to the electronic devices to be configured;
using the user exchange interface (UXI);
establishing a connection with the electronic devices to be configured at the same time;
negotiating protocols with the electronic devices while all the electronic devices are connected;
validating connection with and authentication of the electronic devices while all the electronic devices are connected;
applying initial settings and protocols with the electronic devices while all the electronic devices are connected; and
configuring the electronic devices while all the electronic devices are connected; and
disconnecting communication between the user exchange interface (UXI) and the electronic devices,
wherein each of the plurality of electronic devices are capable of being separately operated as configured.

2. The method of claim 1, wherein the electronic devices to be configured have the same initial Internet Protocol (IP) addresses.

3. The method of claim 1, including creating a Virtual Local Area Network (VLAN), for the electronic devices to be configured.

4. The method of claim 1, including creating a Virtual Local Area Network (VLAN), and associating an identification for the electronic devices to access the VLAN before the electronic devices are configured.

5. The method of claim 1, including creating a Virtual Local Area Network (VLAN), and associating an identification for the electronic devices to access the VLAN before the electronic devices are configured, and wherein a plurality of VLANs are created, and the electronic devices are configured differently for each VLAN.

6. The method of claim 1, including using the user exchange interface (UXI) to assign to the electronic devices the same initial IP address.

7. The method of claim 1, including using a computer with a screen to interface with the user exchange interface (UXI).

8. The method of claim 1, wherein a user provides a set of instructions to the user exchange interface (UXI) for the configuration of the plurality of electronic devices to be configured using a computer with a screen.

9. The method of claim 1, wherein the connection between the user exchange interface (UXI) and the plurality of devices to be configured is established via a wireless communication network.

10. The method of claim 1, wherein the connection between the user exchange interface (UXI) and the plurality of devices to be configured is established via a wired communication network.

11. The method of claim 1, wherein the connection between the user exchange interface (UXI) and the plurality of devices to be configured is established via Ethernet.

12. An apparatus for configuring a plurality of electronic devices comprising:
a user exchange interface (UXI) capable of connecting to the electronic devices to be configured;
said user exchange interface (UXI);
having means of establishing a connection with the electronic devices to be configured at the same time;
having means of negotiating protocols with the electronic devices while all the electronic devices are connected;
having means for validating connection with and authentication of the electronic devices while all the electronic devices are connected;
having means of applying initial settings and protocols with the electronic devices while all the electronic devices are connected; and
configuring the electronic devices while all the electronic devices are connected; and
disconnecting communication between the user exchange interface (UXI) and the electronic devices, and
wherein each of the plurality of electronic devices are capable of being separately operated as configured.

13. The apparatus of claim 12, wherein the electronic devices to be configured have the same initial Internet Protocol (IP) addresses.

14. The apparatus of claim 12, including creating a Virtual Local Area Network (VLAN), for the electronic devices to be configured.

15. The apparatus of claim 12, including creating a Virtual Local Area Network (VLAN), and associating an identification for the electronic devices to access the VLAN before the electronic devices are configured.

16. The apparatus of claim 12, including creating a Virtual Local Area Network (VLAN), and associating an identification for the electronic devices to access the VLAN before the electronic devices are configured, and wherein a plurality of VLANs are created, and the electronic devices are configured differently for each VLAN.

17. The apparatus of claim 12, including using the user exchange interface (UXI) to assign to the electronic devices the same initial IP address.

18. The apparatus of claim 12, including a computer with a screen to interface with the user exchange interface (UXI).

19. The apparatus of claim 12, wherein a user provides a set of instructions to the user exchange interface (UXI) for the configuration of the plurality of electronic devices to be configured via a computer with a screen.

20. The apparatus of claim 12, wherein the connection between the user exchange interface (UXI) and the plurality of devices to be configured is established via a wireless communication network.

21. The apparatus of claim 12, wherein the connection between the user exchange interface (UXI) and the plurality of devices to be configured is established via a wired communication network.

22. The apparatus of claim 12, wherein the connection between the user exchange interface (UXI) and the plurality of devices to be configured is established via Ethernet.

23. A non-transitory computer-readable storage medium with an executable program application stored thereon, the program application configured for coordinating to perform transactions associated with configuring a plurality of electronic devices, the program application configured to be accessible over a communications network, wherein the program application instructs a computer processor to perform the following steps of:
providing a user exchange interface (UXI) capable of connecting to the plurality of electronic devices to be configured;
using the user exchange interface (UXI);
establishing a connection with the electronic devices to be configured at the same time;
negotiating protocols with the electronic devices while all the electronic devices are connected;
validating connection with and authentication of the electronic devices while all the electronic devices are connected;
applying initial settings and protocols with the electronic devices while all the electronic devices are connected; and
configuring the electronic devices while all the electronic devices are connected; and
disconnecting communication between the user exchange interface (UXI) and the electronic devices,
wherein each of the plurality of electronic devices are capable of being separately operated as configured.
